(19) United States
(12) Patent Application Publication
(10) Pub. No.: US 2026/0216875 A1
(43) Pub. Date: Jul. 30, 2026

(54) REAL-TIME AUTONOMOUS HOTSPOT DETECTION IN ELECTRICAL SUBSTATIONS

(71) Applicant: SAUDI ARABIAN OIL COMPANY, Dhahran (SA)

(72) Inventor: Channa Venkata Viswanath, Dhahran (SA)

(73) Assignee: SAUDI ARABIAN OIL COMPANY, Dhahran (SA)

(21) Appl. No.: 19/039,560

(22) Filed: Jan. 28, 2025

(51) Int. Cl. B25J 9/16; G05D 1/646; G05D 1/648; G05D 111/10

(52) U.S. Cl. CPC B25J 9/1679; B25J 9/1697; G05D 1/646; G05D 1/648; G05D 2111/10

(57) ABSTRACT

A method to detect a hotspot in an electrical substation is described. The method includes disposing a robot and an Internet-of-Things (IoT) hub at the electrical substation, inspecting, using the robot controlled via the IoT hub, electrical components of the electrical substation to generate inspection results, transmitting, by the IoT hub, the inspection results to a backend microservice, analyzing, by a machine learning (ML) microservice, in response to the backend microservice receiving the inspection results, the inspection results to generate a response to the backend microservice, where the response includes a prediction of a hotspot in at least one of the electrical components, and performing, based on the response, a maintenance operation of the at least one of the electrical components.

### BACKGROUND

An electrical substation is a part of an electrical distribution system that receives high-voltage electricity from a power plant or transmission line and transforms it into lower voltages for distribution to homes, businesses, and other end-users. Electrical substations are typically composed of various equipment and structures, such as transformers, switchgear, busbars, radiators, protective relays, control systems, and other components that help to control and distribute electrical power. Electrical substations are critical components of the electrical grid that play a crucial role in ensuring the safe, efficient, and reliable distribution of electrical power to end-users.

Transformers are electrical devices that transfer electrical energy by means of a changing magnetic field. They consist of two or more coils of wire and the difference in the number of times each coil wraps around its metallic core determined the change in voltage. This allows for the voltage to be increased or decreased. A bushing is a hollow electrical insulator that allows an electrical conductor to pass safely through a conducting barrier, e.g., the case of a transformer or circuit breaker without making electrical contact. A radiator of the transformer accelerates the cooling rate of transformer, thus plays a vital role in increasing loading capacity of an electrical transformer.

Electrical components of the electrical substation can periodically experience unstable physical connections such as loose contact points, unbalanced loads, insulation cracks. These problems result in dissipation of energy in the form of heat and can create significantly elevated temperatures, resulting in loss of energy. Traditionally, inspection of electrical components in a substation is reactive and manual. Power system inspectors capture IR images with the help of handheld infrared cameras. The manual inspection process is manual and error prone.

### SUMMARY

In general, in one aspect, the invention relates to a method to detect a hotspot in an electrical substation. The method includes disposing a robot and an Internet-of-Things (IoT) hub at the electrical substation, inspecting, using the robot controlled via the IoT hub, a plurality of electrical components of the electrical substation to generate a plurality of inspection results, transmitting, by the IoT hub, the plurality of inspection results to a backend microservice, analyzing, by a machine learning (ML) microservice, in response to the backend microservice receiving the plurality of inspection results, the plurality of inspection results to generate a response to the backend microservice, wherein the response includes a prediction of a hotspot in at least one of the plurality of electrical components, and performing, based on the response, a maintenance operation of the at least one of the plurality of electrical components.

In general, in one aspect, the invention relates to a system to detect a hotspot in an electrical substation. The system includes an Internet-of-Things (IoT) hub that controls a robot at the electrical substation to inspect a plurality of electrical components of the electrical substation to generate a plurality of inspection results, a backend microservice that receives the plurality of inspection results transmitted by the IoT hub, and a machine learning (ML) microservice that analyzes, in response to the backend microservice receiving the plurality of inspection results, the plurality of inspection results to generate a response to the backend microservice, wherein the response includes a prediction of a hotspot in at least one of the plurality of electrical components, wherein a maintenance operation of the at least one of the plurality of electrical components is performed based on the response.

In general, in one aspect, the invention relates to an electrical substation that includes a plurality of electrical components, a robot, and an Internet-of-Things (IoT) hub that controls the robot to inspect the plurality of electrical components substation to generate a plurality of inspection results, and transmits the plurality of inspection results to a backend microservice, wherein, in response to the backend microservice receiving the plurality of inspection results, the plurality of inspection results are analyzed by a machine learning (ML) microservice to generate a response to the backend microservice, wherein the backend microservice and the ML microservice are cloud-based and communicate with each other via Representational State Transfer (REST) application programming interface (API), wherein the response includes a prediction of a hotspot in at least one of the plurality of electrical components, and wherein a maintenance operation of the at least one of the plurality of electrical components is performed based on the response.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a method flowchart in accordance with one or more embodiments.

FIGS. 3A-3E show an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of the ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and system for detecting hotspots in electrical substations. The inspection process uses a robot and a computer vision model to detect hotspots. Infrared camera mounted on an autonomous robot captures infrared images of the critical overheating zones in the substation by traversing through a pre-determined route. The computer vision model utilizes the infrared image and corresponding digital image to detect hotspots and send early detection notifications, enabling the inspectors to maintain the equipment without serious electrical incident.

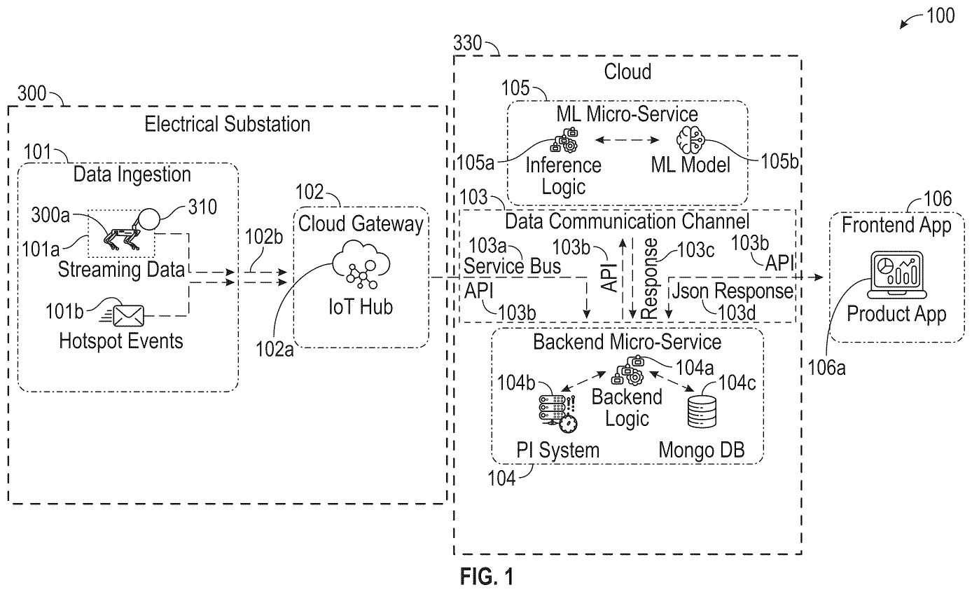

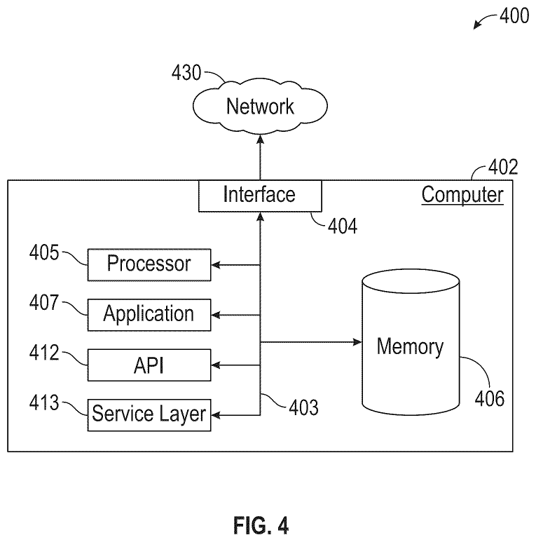

FIG. 1 shows a schematic diagram of a system in accordance with one or more embodiments. In particular, the system (100) is an end-to-end hotspots detection system for electrical substations. One or more modules and/or elements shown in FIG. 1 may be implemented using a computer system such as the computer system (400) described in reference to FIG. 4 below. In one or more embodiments, one or more of the modules and/or elements shown in FIG. 1 may be omitted, repeated, combined, and/or substituted. Accordingly, embodiments disclosed herein should not be considered limited to the specific arrangements of modules and/or elements shown in FIG. 1.

As shown in FIG. 1, the system (100) includes a data ingestion (101), a cloud gateway (102), backend microservices (104), machine learning (ML) microservices (105), and a frontend application (106). Data ingestion is the process of importing large, assorted data files from multiple sources into a single, cloud-based storage medium, such as a data warehouse, data mart or database where the imported data can be accessed and analyzed. The data ingestion (101) involves an infrared camera (310) mounted on a robot (300a) traversing across the electrical substation (300) to capture infrared images (i.e., streaming data (101a)) and streams hotspot events (101b) to the cloud gateway (102). In one or more embodiments, the infrared camera (310) continuously generates data, referred to as hotspot events (101b) that include positional data, substation asset digital images and thermal images. An onboard computer processor of the robot (300a) aggregates and processes data, performs initial analysis, and transmits the collected data over the cloud. The initial analysis is used to move the robot (300a) autonomously.

Hot spots in electrical equipment are caused by loose connections that increase electrical resistance, thus making it harder for electrical current to pass. It is possible for multiple hot spots to occur in one event associated with electrical equipment. Detection of hot spot events allows for early detection of faults and, therefore, helps prevent insulation deterioration and reduce the risk of failures. The temperature of electrical circuits has a dominant influence on insulation life. If a loose joint creates a hot spot, insulation close to that hot spot can suffer serious deterioration due to excessive heating, potentially leading to outages.

In the context of cloud computing, a gateway is a component that acts as a bridge between different networks, allowing data to flow from one to the other. The cloud gateway (102) can be a hardware device or a software application. For example, the cloud gateway (102) includes an Internet-of-Things (IoT) hub (102a), which is a managed service hosted in the cloud that acts as a central message hub for communication between an IoT link/application and its attached devices. For example, the robot (300a) may be equipped with IoT communication capability that communicates with the IoT hub (102a) to receive route navigation information and to transmit the streaming data (101a) and hotspot events (101b).

In one or more embodiments, for example, the IoT application may be a collection of the backend microservices (104), ML microservices (105), and a frontend application (106). Correspondingly, the robot (300a) is the IoT application's attached device. Specifically, the IoT hub (102a) connects, monitors, and controls the robot (300a) in the electrical substation (300). In the context that the backend microservices (104), ML microservices (105), and frontend application (106) are cloud-based, the IoT application is referred to as an IoT cloud application.

In the context of computer software, a service is software that performs automated tasks, responds to hardware events, or listens for data requests from other software. Microservices refer to a suite of small services as building blocks in a single application where each microservice is running in its own process and communicating with lightweight mechanisms, e.g., an HTTP resource Application Programming Interface (API) such as Representational State Transfer (REST) API. The REST API uses HTTP requests to access and use data based on Representational State Transfer, an architectural style and approach to communications used in web services development. A service bus, such as a RabitMQ bus, is a communication link between microservices through which microservices can publish messages under different numbers of queues available inside the RabbitMQ service bus.

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among classical arts like mathematics, statistics, and computer science. For consistency, the term machine learning (ML), or machine-learned, will be adopted herein, however, one skilled in the art will recognize that the concepts and methods detailed hereafter are not limited by this choice of nomenclature.

Machine-learned model types may include, but are not limited to, k-means, k-nearest neighbors, neural networks, logistic regression, random forests, generalized linear models, and Bayesian regression. Also, machine-learning encompasses model types that may further be categorized as “supervised,” “unsupervised,” “semi-supervised,” or “reinforcement” models. One with ordinary skill in the art will appreciate that additional or alternate machine-learned model categorizations may be defined without departing from the scope of this disclosure. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

A cursory introduction to a few machine-learned models and the general principles related to training a supervised machine-learned model are provided below. However, while descriptions of machine-learned models are provided to aid in understanding, one with ordinary skill in the art will recognize that these descriptions do not impose a limitation on the instant disclosure. This is because one with ordinary skill in the art will appreciate that, due to the depth and breadth of the field, a detailed description of the field of machine learning, and the various model types encompassed by the field, cannot be adequately summarized in the present disclosure.

In machine learning, algorithms are trained to find patterns and correlations in large training data sets and to make the best decisions and predictions based on that analysis. Machine learning algorithms build a model based on sample data, known as training data, in order to make predictions or decisions without being explicitly programmed to do so. A training data set is a dataset of examples used during the learning process to fit the parameters of machine learning algorithms, such as weights of a classifier.

Artificial neural networks (ANNs) are a subset of machine learning in deep learning algorithms. The ANN includes node layers, i.e., an input layer, one or more hidden layers, and an output layer. Each node connects to another node and has an associated weight and threshold. If the output of any individual node is above the specified threshold value, that node is activated, sending data to the next layer of the network. Otherwise, no data is passed along to the next layer of the network. ANNs rely on training data to learn and improve their accuracy over time. A convolutional neural network (CNN) is a class of ANN most commonly applied to analyze visual imagery. CNNs use a mathematical operation called convolution in place of general matrix multiplication in at least one of their layers. CNNs are specifically designed to process pixel data and are used in image recognition and processing.

Based on the foregoing, the core image training datasets (206) are machine learning training datasets for training machine learning (ML) models. Specifically, the core image training datasets (206) includes a primary machine learning training dataset for training a primary ML model and a secondary machine learning training dataset for training a secondary ML model.

As shown in FIG. 1, the backend microservice (104) and ML microservice (105) are hosted in the cloud (330) and communicate with each via a data communication channel (103) (e.g., service bus (103a)), API (103b)). In the context of cloud computing, the cloud is a collection of computing services, including servers, storage, databases, networking, software, analytics, and intelligence that are provided and accessible over the internet. The backend microservice (104) includes backend logic (104a), source system (104b), and backend database (104c). The backend logic (104a) is a control function of the backend microservice (104) while the backend database (104c) stores data used or generated by the backend microservice (104). For example, the backend database (104c) may be a document database such as, for example, Mongo DB. In addition, the source system (104b) stores and manages information regarding the electrical substation and may be referred to as a plant information (PI) system. Upon receipt of hotspot events (101b) via the IoT hub (102a), the backend logic (104a) updates the source system (104b) and triggers the ML microservice (105). The response (103c) from the ML microservice (105) in the form of predictions is updated in the backend database (104c).

The ML microservices (105) includes inference logic (104a) and ML model (104b), which may be a computer vision model. A computer vision model is a software program that is trained to detect objects in images. A model learns to recognize a set of objects by first analyzing images of those objects through training. As noted above regarding Machine learning (ML), training involves creating a model, training it with labeled data, and testing and validating it with unseen data. On the other hand, inference involves using the trained model to process live data and produce an actionable output. The inference system accepts inputs from users, processes the data, feeds it into the model, and then serves outputs back to users. In an example scenario, the computer vision model is trained on 1000+ labelled images across four electrical substation components: transformer, transformer bushing, radiator, and voltage transformer. Voltage transformer is a specialized type of transformer used to reduce high voltage to safe measurable voltage whereas transformer refers to any transformer used to step up or step down voltage in a substation. The computer vision model (104b) performs inference on both digital and thermal images. As noted above, a hotspot event is combination of positional data, digital image and thermal or IR image. In one or more embodiments, the computer vision model (104b) runs inference on hotspot events (101b) and sends back the predictions as response (103c) to the backend microservices (105). For example, the response (103c) may include hotspot information, such as asset type (e.g., voltage transformer), asset health (e.g., normal), asset temperature (e.g., 50 degrees), etc.

In one or more embodiments, the IoT hub (102a) and the cloud (330) form a hub-cloud platform to jointly execute the IoT application of the end-to-end hotspots detection system (100). Services, made available through the hub-cloud platform may include, for example, providing data to the user, enabling the user to configure the system, etc. The hub-cloud platform may be accessed by a user using a user application such as a frontend application (106), which may be executing on a computing device such as a smartphone or a laptop. The user application, thus, may provide a user interface configured to enable the user to access the hub-cloud platform, and to receive notifications on critical events. The user application may include for example, alert displays, status messages, data visualization capabilities, control and configuration capabilities, etc. The user application may further provide data entry fields (e.g., to configure the system), specialized control interfaces (e.g., to control the robot), etc. Alternative implementations of the user application may operate on other devices, e.g., on an audio alert device.

The frontend application (106) is the interface of the IoT application referred to as the product App (106a). More specifically, the frontend application (106) is the frontend/user interface for the application which aids users to track key electrical assets and their asset conditions. The frontend application (106) gives an overview of all the assets, their health and the asset temperature. It also helps the user to perform any preliminary investigation required for critical assets. In one or more embodiments, the user (e.g., a human inspector for the electrical substation) interacts with the IoT application through buttons, images, interactive elements, navigational menus, and text. For example, the user may send requests to the backend microservices (104) to fetch data, submit forms and create dynamic user experiences. The user performs actions on the user interface to track the asset status. The backend microservices fetch the data of the particular asset, its health and temperature in an interactive manner. For example, the data may include hotspot information that is fetched as Json response (103d).

In summary, the inspection process uses a robot and a computer vision model to detect hotspots in an electrical substation. Infrared camera mounted on an autonomous robot captures infrared images of the critical overheating zones in the substation by traversing through a fixed route. The robot traverses through the substation and captures digital and thermal images. An optimal route from its starting point to a desired destination is defined through path planning of the robot. Cameras onboard the robot provide real-time data such as images etc., and the path and camera position are updated accordingly. The real time data is fed to computer vision algorithms for path planning to identify various assets and update the path accordingly. The computer vision model utilizes the infrared image and digital image (which may be captured by the same camera or two different cameras) to detect hotspots and send early detection notifications, enabling the inspectors to maintain the equipment without serious electrical incident. The combination of digital image, thermal image and positional data is referred to as hotspot events which are streamed by the robot. The computer vision model is used to identify the asset type and asset semantic segments from the digital images. Similarly, another computer vision model extracts the temperature information from IR images using the semantic segments extracted from digital images.

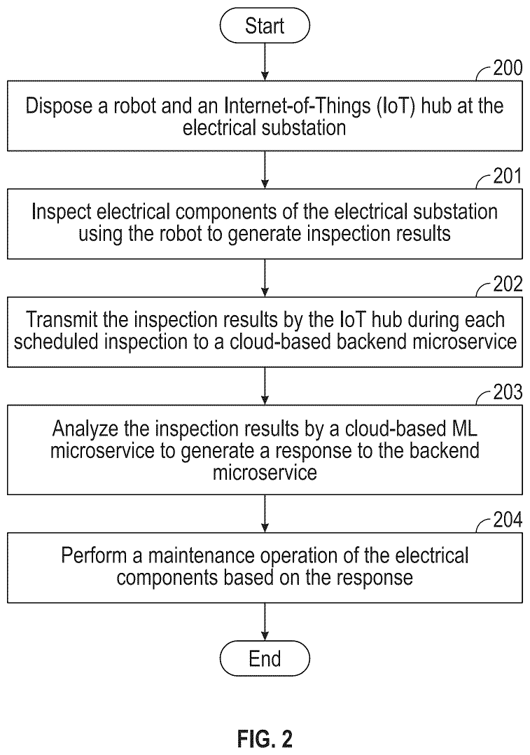

FIG. 2 shows a flowchart in accordance with one or more embodiments disclosed herein. Specifically, the flowchart depicted in FIG. 2 illustrate a method to detect a hotspot in an electrical substation. One or more of the steps in FIG. 2 may be performed by the components of the system (100) discussed above in reference to FIG. 1. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

Initially in Step 200, a robot and an Internet-of-Things (IoT) hub are disposed at the electrical substation. In one or more embodiments, the IoT hub is permanently installed, and weather protected at the electrical substation. For example, the IoT hub may be placed in a water-proof enclosure next to the electrical components of the electrical substation. In one or more embodiments, the robot may be dispatched to the electrical substation according to a pre-determined inspection schedule (e.g., monthly, quarterly, annually, etc.) of the electrical substation.

In Block 201, electrical components of the electrical substation are inspected using the robot to generate inspection results. In one or more embodiments, the IoT hub obtains routing information from a cloud-based backend microservice to direct the robot to traverse a path about the electrical substation. In one or more embodiments, the routing information is site-specific, i.e., specific to each electrical substation listed on the pre-determined inspection schedule and defines the site-specific path traversed by the robot to pass by each electrical component during inspection.

In one or more embodiments, a camera device mounted on the robot captures images of each electrical component as the robot passes the electrical components one at a time while traversing the path. The images include a digital image captured using a visible light camera sensor and an infrared image captured using an infrared image sensor. The capture images are consolidated into the inspection results.

In Block 202, during each scheduled inspection, the inspection results with the captured images are transmitted by the IoT hub to a cloud-based backend microservice. In one or more embodiments, the backend microservice and a machine learning (ML) microservice are both cloud-based and communicate with each other via an application programming interface (API), for example a Representational State Transfer (REST) API.

In one or more embodiments, during a training phase prior to starting the inspection schedule (e.g., monthly, quarterly, annually, etc.), training images are captured using the camera device as the robot traverses the path and passes by each electrical component. Accordingly, an ML model is trained using the training images prior to being deployed to the ML microservice. For example, the ML model may be a computer vision model. Training data includes both normal and abnormal conditions. In one or more embodiments image augmentation techniques are used to create more samples of data from the data collected through field visits. All data is collected from operating conditions across several assets.

In Block 203, in response to the backend microservice receiving the inspection results during a scheduled inspection subsequent to the training phase, the inspection results are analyzed by the ML microservice to generate a response to the backend microservice. In one or more embodiments, two computer vision models are used to identify the hotspot event. The first model uses a digital image is used to identify the asset type and its semantic segments. The second model uses a thermal image to extract the temperature information. Both the computer vision models may be any suitable objection detection models, for example, YoLoV7. In addition to the above, a computer vision algorithm is used by the robot to traverse the station autonomously. This model is used for obstacle avoidance and efficient collection of asset event data. In one or more embodiments, the images in the inspection results are analyzed using an inference logic of the ML microservice based on the trained ML model to generate the response. In one or more embodiments, the response includes a prediction of a hotspot in one or more pieces of electrical components.

In Block 204, a maintenance operation of the electrical components is performed based on the response. For example, the predicted hotspot may be verified by a dispatched maintenance technician followed by necessary adjustments and/or repairs. In one or more embodiments, the maintenance operation is initiated by the backend microservice without user intervention. In one or more embodiments, the maintenance operation is initiated by a user accessing the response for review using a frontend application. In one or more embodiments, the frontend application displays a dashboard for the response information to be presented. For example, the response information may include the health status of the electrical component such as NORMAL, MINOR, MODERATE, CRITICAL that are defined based on severity of the predicted hotspot.

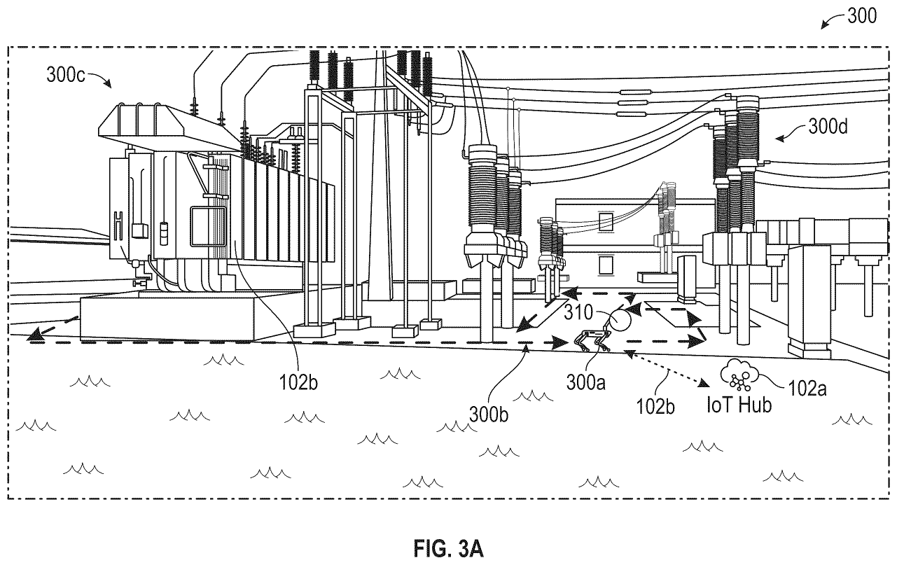

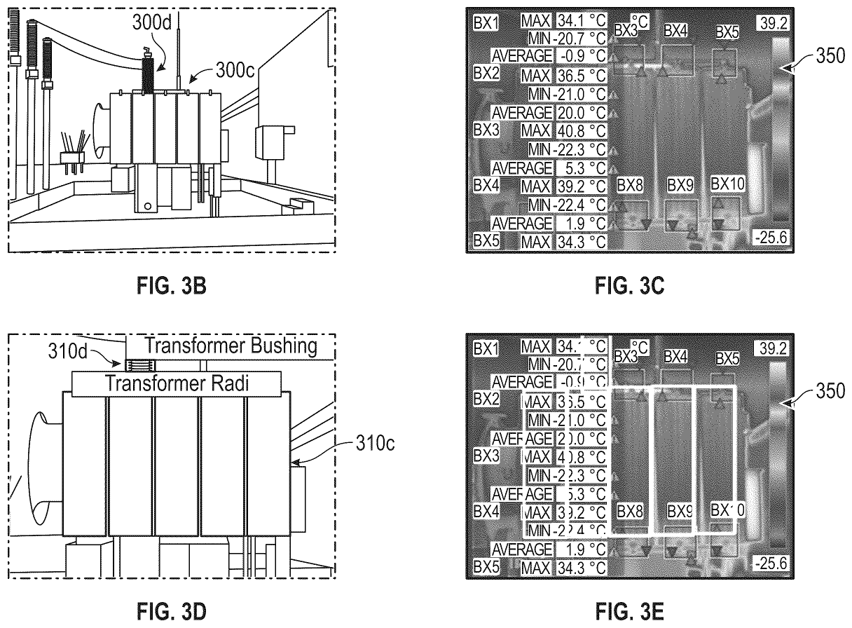

FIGS. 3A-3E show an implementation example in accordance with one or more embodiments. The implementation example shown in FIGS. 3A-3E is based on the system and method flowchart described in reference to FIGS. 1 and 2 above. In one or more embodiments, one or more of the modules and/or elements shown in FIGS. 3A-3E may be omitted, repeated, combined, and/or substituted. Accordingly, embodiments disclosed herein should not be considered limited to the specific arrangements of modules and/or elements shown in FIGS. 3A-3E.

FIG. 3A shows a photograph of an example electrical substation (300). For example, the photograph shows a robot (300a) in the form of a mechanical dog traversing a fixed route (300b) along a collection of transformers (300c), bushings (300d), and other electrical equipment of the electrical substation (300). The robot (300a) communicates, using an IoT link (102b), with an IoT hub (102a), which is an onsite equipment installed at the electrical substation (300). As described above, the infrared and digital images captured by the camera (310) mounted on the robot (300a) are transmitted via the IoT hub (102a) to the cloud to be processed and used by the microservices and frontend application collectively forming the IoT application.

As shown in FIG. 3A, the electrical equipment referred to as assets in the electrical substation (300) are complex and connected. Quite often, the background and foreground of an asset image captured by the camera (310) may include a transformer bushing that contains another asset such as a disconnect switch. The ability to detect assets in such a complex setting is difficult. However, the computer vision model described above performs well even subject to noise and variance in sunlight conditions.

The robot (300a) is registered as an IoT device in the IoTHub (102a). The robot (300a) can be controlled manually through a user interface installed in the IoThub (102a) or autonomously using path planning and computer vision algorithms. Autonomous control of robot (300a) is based on path planning and computer vision algorithm. An optimal route from its starting point to a desired destination is defined through path planning of the robot (300a). Camera (310) onboard the robot (300a) provides real time data such as position, images etc., and the path and camera position are updated accordingly based on the robot's current position. The real-time data is fed to computer vision algorithms for path planning to identify various assets and update the path accordingly.

FIG. 3B shows one of many digital images of the example electrical substation (300) depicted in FIG. 3A above. In particular, the digital image includes a bank of transformers (300c) and a transformer bushing (300d) and may be used as an input to the backend microservices and ML microservices for training or inference.

FIG. 3C shows one of many infrared images of the example electrical substation (300) depicted in FIG. 3A above. In particular, the infrared image corresponds to the digital image shown in FIG. 3B above. In the infrared image, the temperatures of various spot throughout the transformers (300c) and transformer bushing (300d) are represented according to the grey scale (350).

Along with the digital image depicted in FIG. 3B above, the infrared image is also used as an input to the backend microservices and ML microservices for training or inference.

FIG. 3D shows the digital image depicted in FIG. 3A above where the bank of transformers (300c) and the transformer bushing (300d) are annotated according to the inference results of the computer vision model. The annotated digital image is part of the response provided by the ML microservice to the backend microservice and may be accessed by the frontend application of the user.

FIG. 3E shows the infrared image depicted in FIG. 3A above where the bank of transformers (300c) and the transformer bushing (300d) are annotated according to the inference results of the computer vision model. The annotated infrared image is part of the response provided by the ML microservice to the backend microservice and may be accessed by the frontend application of the user.

As described in the example depicted in FIGS. 3A-3E above, robots improve safety as they are capable of working in hazardous environments. Computer vision systems carry out repetitive and monotonous tasks such as hot spot identification at a faster rate. The cloud technology helps scalability across substation by establishing connectivity and improving accessibility. IoT hub aids to monitor, provision and control robots. The example uses an integrated approach of using robotics, computer vision, cloud integration and automation to perform asset inspection at a substation. This integrated approach of robot driven autonomous inspection is regular, fast, accurate and results in scheduled outages. When an electrical asset exceeds a critical temperature, it may result in forced outages leading to power interruptions, equipment damage etc. Autonomous inspections can increase the frequency of inspection and get real time updates on asset health and temperature. This will enable the substation inspectors schedule outages (power interruptions) and repair the equipment before they malfunction.

Embodiments disclosed herein have the following advantages:

Alert Classification: Computer vision models using the digital image detect the asset type (ex: Transformer Radiator) and extracts the semantic segments of the assets. Another Computer vision model uses IR image and extract the temperature from the region of interest. Based on the temperature of the asset and critical temperature of the asset, alert is generated and classifies as Normal, Minor, Moderate or Critical. Alert classification enables the substation inspectors to prioritize alerts and take action accordingly.

HotSpot Alert Notification system: The alerts generated are sent as notifications to the substation inspectors. These notifications enable the inspectors to take proactive maintenance decisions.

Asset Detection Model: There are multiple assets in a substation such as Transformer Radiator, Voltage transformer, Transformer Bushing, Surge Arrestors etc. Computer vision asset detection model detects these assets.

Time series history of the assets: Time series history of asset can be used to track and identify abnormal assets and manage the lifecycle of the asset.

Geo tagging of assets: Geo tagging the assets will identify the exact location of assets and enable faster response by maintenance team in case of a failure.

Weather API integration: Relative temperature is a key indicator of asset health. Local weather conditions can provide more information on the type of asset condition.

Embodiments disclosed herein may be implemented on a computer system. For example, a computer system such as that shown in FIG. 4 may be implemented as part of the robot or may be operatively connected to the robot in order to process the images taken by the robot camera and execute the computational models. FIG. 4 is a block diagram of a computer system (400) used to provide computational functionalities associated with the described computational models, algorithms, methods, functions, processes, flows, and procedures as described in the instant disclosure, according to an implementation. The illustrated computer system (400) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system (400) may include a computer (402) that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as a child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402), and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FAAS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method to detect a hotspot in an electrical substation, comprising:
disposing a robot and an Internet-of-Things (IoT) hub at the electrical substation;
inspecting, using the robot controlled via the IoT hub, a plurality of electrical components of the electrical substation to generate a plurality of inspection results;
transmitting, by the IoT hub, the plurality of inspection results to a backend microservice;
analyzing, by a machine learning (ML) microservice, in response to the backend microservice receiving the plurality of inspection results, the plurality of inspection results to generate a response to the backend microservice, wherein the response includes a prediction of a hotspot in at least one of the plurality of electrical components; and
performing, based on the response, a maintenance operation of the at least one of the plurality of electrical components.

2. The method of claim 1, further comprising:
initiating, based on the response from the ML microservice and by the backend microservice without user intervention, the maintenance operation.

3. The method of claim 1, further comprising:
accessing, using a frontend application of a user, the response from the ML microservice; and
initiating, based on the response and by the user, the maintenance operation.

4. The method of claim 1, further comprising:
directing, via the IoT hub and based on routing information from the backend microservice, the robot to traverse a path about the electrical substation,
wherein inspecting the plurality of electrical components comprising capturing a plurality of images using a camera device mounted on the robot, and
wherein the plurality of inspection results comprises the plurality of images.

5. The method of claim 4, further comprising:
training, using a plurality of training images during a training phase, an ML model of the ML microservice,
wherein the plurality of training images are captured using the camera device as the robot traverses the path during the training phase.

6. The method of claim 5, wherein analyzing the plurality of inspection results comprises:
analyzing, using an inference logic of the ML microservice and subsequent to the training phase, the plurality of images based on the trained ML model.

7. The method of claim 1,
wherein the backend microservice and the ML microservice are cloud-based and communicate with each other via Representational State Transfer (REST) application programming interface (API).

8. A system to detect a hotspot in an electrical substation, comprising:
an Internet-of-Things (IoT) hub that controls a robot at the electrical substation to inspect a plurality of electrical components of the electrical substation to generate a plurality of inspection results;
a backend microservice that receives the plurality of inspection results transmitted by the IoT hub; and
a machine learning (ML) microservice that analyzes, in response to the backend microservice receiving the plurality of inspection results, the plurality of inspection results to generate a response to the backend microservice, wherein the response includes a prediction of a hotspot in at least one of the plurality of electrical components,
wherein a maintenance operation of the at least one of the plurality of electrical components is performed based on the response.

9. The system of claim 8,
wherein the backend microservice initiates, based on the response from the ML microservice and without user intervention, the maintenance operation.

10. The system of claim 8, further comprising:
a frontend application of a user that accesses the response from the ML microservice,
wherein the maintenance operation is initiated by the user based on the response.

11. The system of claim 8,
wherein the IoT hub directs, based on routing information from the backend microservice, the robot to traverse a path about the electrical substation,
wherein inspecting the plurality of electrical components comprising capturing a plurality of images using a camera device mounted on the robot, and
wherein the plurality of inspection results comprises the plurality of images.

12. The system of claim 11,
wherein the ML microservice comprises an ML model that is trained using a plurality of training images during a training phase,
wherein the plurality of training images are captured using the camera device as the robot traverses the path during the training phase.

13. The system of claim 12, wherein analyzing the plurality of inspection results comprises:
wherein the ML microservice further comprises an inference logic that analyzes, subsequent to the training phase, the plurality of images based on the trained ML model.

14. The system of claim 8,
wherein the backend microservice and the ML microservice are cloud-based and communicate with each other via Representational State Transfer (REST) application programming interface (API).

15. An electrical substation comprising:
a plurality of electrical components;
a robot; and
an Internet-of-Things (IoT) hub that
controls the robot to inspect the plurality of electrical components substation to generate a plurality of inspection results; and
transmits the plurality of inspection results to a backend microservice;
wherein, in response to the backend microservice receiving the plurality of inspection results, the plurality of inspection results are analyzed by a machine learning (ML) microservice to generate a response to the backend microservice,
wherein the backend microservice and the ML microservice are cloud-based and communicate with each other via Representational State Transfer (REST) application programming interface (API),
wherein the response includes a prediction of a hotspot in at least one of the plurality of electrical components, and
wherein a maintenance operation of the at least one of the plurality of electrical components is performed based on the response.

16. The electrical substation of claim 15,
wherein the maintenance operation is initiated by the backend microservice based on the response from the ML microservice and without user intervention.

17. The electrical substation of claim 15,
wherein the response from the ML microservice is accessed by a user using a frontend application, and
wherein the maintenance operation is initiated by the user based on the response.

18. The electrical substation of claim 15,
wherein the IoT hub directs, based on routing information from the backend microservice, the robot to traverse a path about the electrical substation,
wherein inspecting the plurality of electrical components comprising capturing a plurality of images using a camera device mounted on the robot, and
wherein the plurality of inspection results comprises the plurality of images.

19. The electrical substation of claim 18,
wherein an ML model of the ML microservice is trained using a plurality of training images during a training phase, and
wherein the plurality of training images are captured using the camera device as the robot traverses the path during the training phase.

20. The electrical substation of claim 19, wherein analyzing the plurality of inspection results comprises:
analyzing, using an inference logic of the ML microservice and subsequent to the training phase, the plurality of images based on the trained ML model.
